(19) United States
(12) Patent Application Publication
(10) Pub. No.: US 2016/0227816 A1
(43) Pub. Date: Aug. 11, 2016

(54) PROCESS FOR THE PRODUCTION OF GRANULES HAVING GREATLY IMPROVED PROPERTIES FROM AMINO ACID SOLUTIONS AND SUSPENSIONS

(71) Applicants: Hans Christian ALT, Gelnhausen (DE); Martin KÖRFER, Kahl (DE); Horst PRIEFERT, Ostbevern (DE); Harald JAKOB, Hasselroth (DE); Wilfried BLÜMKE, Schöneck (DE); Ansgar OELMANN, Gelnhausen (DE); EVONIK DEGUSSA GMBH, Essen (DE)

(72) Inventors: Hans Christian Alt, Gelnhausen (DE); Martin Körfer, Kahl (DE); Horst Priefert, Ostbevern (DE); Harald Jakob, Hasselroth (DE); Wilfried Blümke, Schöneck (DE); Ansgar Oelmann, Gelnhausen (DE)

(21) Appl. No.: 15/022,642

(22) PCT Filed: Sep. 10, 2014
(86) PCT No.: PCT/EP2014/069287

§ 371 Date: Mar. 17, 2016

(30) Foreign Application Priority Data
Sep. 17, 2013 (EP) 13184750.1

(51) Int. Cl. A23K 20/142; F26B 3/084; A23K 40/00

(52) U.S. Cl. CPC A23K 20/142; A23K 40/00; F26B 3/084

(57) ABSTRACT

The application relates to a process for the production of granules optimized for feed use containing amino acids and optionally constituents of the fermentation broth for use as feed additives, the granulation being carried out in a stationary or circulating fluidized bed, an aqueous suspension or an aqueous solution of the amino acid being sprayed in a granulation chamber containing a fluidized bed, the drying gas flow on flowing into the granulation chamber having a temperature of 120 to 450° C. and a water vapour content of more than 16 g of water/kg of drying gas.

The invention relates to a process for the production of granules comprising amino acids and optionally constituents of the fermentation broth for use as feed additives, the granulation being carried out in a stationary or circulating fluidized bed. The process is particularly suitable for the production of granules from aqueous amino acid solutions and suspensions.

Animal feeds are supplemented with individual amino acids according to the need of the animals. For the supplementation of animal feeds, e.g. with L-lysine, up to now mainly L-lysine monohydrochloride having an L-lysine content of 78% is employed. Since the L-lysine is produced by fermentation, for the production of the monohydrochloride it must first be separated from all other constituents of the crude fermentation broth in laborious process steps, then converted to the monohydrochloride and the latter must be crystallized. Here, a large number of by-products and the reagents necessary for working up result as waste. As a high purity of the animal feed supplement is not always necessary and furthermore nutritionally active valuable substances are often still contained in the by-products of the fermentation, in the past attempts to convert L-lysine together with constituents of the fermentation broth inexpensively into a solid animal feed have therefore not been lacking.

The complex composition of such media has proved to be a disadvantage in processing. These can generally only be dried with difficulty, the dried products are often hygroscopic, virtually non-flowable, at risk of clumping, and are not suitable for the technically demanding processing in mixed feed factories. The products from the fermentation for the production of lysine are especially to be mentioned here. The simple dehydration of the crude fermentation broth by spray drying leads to a dusty, strongly hygroscopic and, after a short storage time, lumpy concentrate, which cannot be employed in this form as an animal feed.

The use of a spray drier having an integrated fluidized bed yields a finely divided and porous, but flowable, spray dried powder of very low bulk density and still higher hygroscopicity. Considerable dust exposure results in the handling of this product.

Pelleting in the fluidized bed likewise proved to be not very suitable, as large amounts of additives (as a rule more than 10% by weight) are also necessary here, these being added continuously according to DD 268 856. Their use is in particular therefore essential here to bind the water from the fermentation broth, and so to prevent clumping of the granules, which in particular would have a disadvantageous effect in pelleting.

Further processes for the granulation of animal feed additives containing amino acids based on fermentation broth are known from U.S. Pat. No. 4,777,051, EP 0 615 693 B and EP 0 533 039 B.

U.S. Pat. No. 4,777,051 discloses a spray drying process having an additional drying step downstream. Tryptophan or threonine solutions of differing origin having a content of 20-60% by weight, based on the total solid content, are sprayed in a first step to give half-dry granules containing 5-15% residual moisture. Subsequently, the moist granules are spread out on a conveyor dryer with a perforated bottom and finally dried with hot air, a product of approximately 4% by weight residual moisture being obtained.

According to EP 0 615 693, the granulation is likewise carried out in a two-stage drying process. After removal of a part of the ingredients, the fermentation broth is optionally spray dried to give a fine grain, which has a maximum particle size of 100 μm to at least 70% by weight, and the fine grain thus obtained is built up in a second stage to give granules, which contain fine grain to at least 30% by weight.

Besides the two-stage structure of the drying/granulation process, it is a disadvantage in this process that the granulation can only take place batchwise and not continuously.

A process for the granulation of an animal feed additive based on a fermentation broth is likewise known from EP 0 809 940 B1. The process is wherein the fermentation broth is granulated, compacted and dried in one step in a fluidized bed, while an amount of energy adequate for the adjustment of a desired grain diameter and a desired bulk density additionally to the energy needed for the production of the stationary fluidized bed is added to the fluidized bed mechanically.

An essential feature of fluidized bed spray granulation is the formation of a stable fluidized bed within the granulator. This means that the velocity of the inflow medium must be chosen such that the fluidization of the particles to be dried occurs but pneumatic delivery is avoided. It is thus ensured that although the particles formed are not discharged, a continuous change of place of the particles takes place, such that a uniform impact probability for the droplets sprayed in is afforded.

This process exhibits the known disadvantages of fluidized bed spray granulation. These are mainly:

With decreasing particle size, the velocity of the inflow medium must be greatly reduced in order that a stable stationary fluidized bed is maintained and discharge of the particles from the granulator is avoided. As in this process the inflow medium is the energy carrier, the efficiency decreases extremely. The achievable build-up rates are too low to be still able to operate the granulation process economically.

A process of this type is described in U.S. Pat. No. 4,946,654. A loss of material by the discharge of dust is avoided in that this is separated from the gas flowing from the granulator and is returned to the fluidized bed.

On the part of the markets, increasingly higher demands are placed on feed amino acids in the form of solids with regard to their bulk material properties. Thus the products produced should be dust-free and readily pourable, and have a narrow particle size distribution and a bulk density as high as possible. Moreover, they should be highly stable to abrasion and have reduced hygroscopicity. However, the visual disposition is also gaining more and more importance.

While nearly spherical and thus readily pourable particles can certainly be produced by known spray drying processes, such particles are hollow spheres with low density and an undesired proneness to dust formation. In contrast, approximately spherical massive particles can be produced by a fluidized bed spray granulation.

WO 2005/006875 describes the granulation of amino acids from fermentations, the granulation being carried out in a circulating fluidized bed, and the inflow velocity of the drying flow being adjusted such that 30 to 100% by weight of the solid particles, based on the fluidized bed in the granulation chamber, continuously leave this chamber upwards, then are separated from the gas flow and are led back into the granulation chamber. The granulation of amino acids from fermentations is also described in WO 2008/077774 A1.

These processes function very well with amino acids soluble in water. By the crystallization of the dissolved amino acid during the drying off of the solvent, very solid granules are produced. With more poorly soluble amino acids, if solutions are to be sprayed, the concentration of the spray solution is very much lower. This leads as a result to large amounts of solvent, which must be evaporated. The process thereby becomes uneconomical. If particle-containing suspensions of higher amino acid concentration are sprayed, the crystallization effect is not adequate for the particle binding. In the case of threonine, this can partially be compensated by overheating. This leads, however, to further disadvantages such as thermal stress and fine grain production due to flash evaporation.

Up to now, no industrial process is known, according to which granular bulk goods of high quality are obtained by the direct spraying of concentrated particle-containing suspensions of water-soluble amino acids.

It is therefore the object of the present invention to provide an efficient process that can be carried out continuously for the granulation of a feed additive comprising amino acids, the additive preferably being a fermentation product and optionally containing further ingredients including the biomass from the fermentation broth, the conversion of water-soluble amino acids also having a relatively high concentration of the undissolved constituents from fermentation processes to qualitatively high-grade bulk goods appropriate to the application also being economically feasible. Very particular emphasis is also to be directed at the visual disposition of the granules produced. An as light as possible but absolutely uniformly coloured product is necessary.

The invention provides a process for the production of granules comprising amino acids and optionally constituents of the fermentation broth for use as feed additives, wherein an aqueous suspension or an aqueous solution comprising an amino acid is sprayed in a granulation chamber equipped with a stationary or circulating fluidized bed and wherein the drying gas flow on flowing into the granulation chamber has a temperature of 120 to 450° C. and a water vapour content of more than 16 g of water/kg of drying gas.

The invention is directed at a process for the production of granules in a fluidized bed, a liquid suspension comprising an amino acid, preferably suspension from a fermentation, being sprayed onto particles situated in the fluidized bed with a smaller mean diameter than those of the particles to be produced and simultaneously water contained in the medium being evaporated. Using the process according to the invention, with concentrated suspensions and solutions comprising water-soluble amino acids from fermentation processes such as L-lysine, L-methionine, L-threonine, L-tryptophan, and L-valine, spherical, shell-like, high-strength, dense and abrasion-stable granules can be produced, which are clearly superior to granules according to WO 2005/006875 and WO 2008/077774 A1. The hygroscopicity is a chemical substance characteristic of the granule ingredients, which basically persists. Owing to the tighter more compact structure and the thereby reduced effective surface area, the negative effects of the hygroscopicity of the granules are greatly reduced.

The increase of the water vapour loading of the ingoing drying gas leads as a result also to a higher water vapour concentration in the process area and also in the drying gas flowing off. As a further result, to ensure the residual moisture of the finished granules, the process temperature of the granulation must also be increased. Surprisingly, it has been found that the granulation of the amino acids in a granulation plant with circulation of the drying gas succeeds better in conditions more unfavourable for the actual drying. The person skilled in the art would rather suggest a drying gas as dry as possible for an efficient water removal. Thus the water vapour loading of the ingoing drying gas in conventional fluidized bed granulation processes is 3-15 g of water/kg of drying gas.

The following parameters of the gas flowing through the fluidized bed are preferred for the process according to the invention:

In a preferred process, the drying gas flow on flowing into the granulation chamber has a water vapour content of 20 to 90 g of water/kg of drying gas, particularly preferably of 20 to 70 g of water/kg of drying gas.

In a further embodiment of the process according to the invention, the drying gas flow on flowing into the granulation chamber consists completely of superheated steam guided in circulation.

In a further variation of process according to the invention, the drying gas flow on flowing into the granulation chamber has a temperature of 150 to 450° C., preferably 250 to 450° C. and particularly preferably 350 to 450° C.

Furthermore, the drying gas flow on flowing into the granulation chamber preferably has a temperature of 250 to 450° C. and a water vapour content of 20 to 70 g of water/kg of drying gas.

A further embodiment of the process according to the invention is that the drying gas flow on flowing into the granulation chamber has a temperature of 350 to 450° C. and a water vapour content of 20 to 70 g of water/kg of drying gas.

In a further variation of the inventive process, the drying gas flow on exit from the granulation chamber has a relative gas humidity of 10 to 90% drying gas, preferably 15 to 60%, further preferably 20 to 50%.

In an alternative embodiment, the drying gas flow on exit from the granulation chamber has an absolute gas humidity of 20 to 200 g of water/kg of drying gas, preferably 35 to 150 g of water/kg of drying gas, further preferably 50 to 120 g of water/kg of drying gas.

A further embodiment of the process according to the present invention comprises the following steps, where:
a) an aqueous suspension or an aqueous solution of the amino acid is sprayed in a granulation chamber equipped with a fluidized bed,
b) at least 10% by weight of the particles situated in the chamber are discharged from the granulation chamber with the drying gas,
c) then the discharged particles are separated from the gas flow,
d) the particles of the fluidized bed separated off are at least partially fed again (b-d: circulation) at >75%, preferably at >85% and particularly preferably at >95% while
e) granulated particles with a size within the desired particle size range are removed continuously from the chamber in an amount such that the amount of the solid situated in the chamber remains constant.

In a further variation of the inventive process, the gas flow freed from the discharged particles is fed back into the granulation chamber optionally by means of a device for warming the gas flow such that the amount of gas circulating internally remains constant and only the excess gas is discharged. The gas necessary for the maintenance of the fluidized bed and gas necessary for the substance and heat transport is therefore preferably recirculated (recycle gas).

The gas flow freed from the discharged particles is thus preferably fed back at least partially, in particular at least to 50%, 60%, 70%, 80%, 90%, 95%, 98% into the granulation chamber, and particularly preferably by means of an apparatus for heating the gas flow.

The energy-generating combustion of natural gas leads to the desired depletion of oxygen in the cycle gas. It is essential, as explained above, that the water vapour load of the cycle gas is increased. A particularly preferred embodiment is further the direct flue gas utilization of combusted natural gas and the use of the gas recycling described above. The atmospheric oxygen can thereby be reduced without use of expensive inert gases such that dust-explosive products can be processed. Relatively high admission temperatures can easily be realized. This further leads to the fact that a very elevated concentration of CO₂ and water vapour compared to the ambient air is already present in the gas flowing into the fluidizing chamber. The concentration of water vapour can be further influenced by means of the condensation temperature in the cycle gas.

In a further variation of the inventive process, the drying gas flow on flowing into the granulation chamber has a residual oxygen content of 1 to 15% by volume, preferably of 1 to 12% by volume, further preferably of 1 to 10% by volume, and particularly preferably of 1 to 8% by volume. The other portion of the respective drying gas flow consists essentially of nitrogen, water vapour and carbon dioxide.

In a further variation of the inventive process the drying gas flow on flowing into the granulation chamber has a CO₂ content of at least 6% by volume; and in particular an oxygen content of 1 to 15% by volume, preferably of 1 to 12% by volume, further preferably of 1 to 10% by volume, and particularly preferably of 1 to 8% by volume. In particular, it is preferred that the drying gas flow on flowing into the granulation chamber has a CO₂ content of at least 6% by volume and an oxygen content of 1 to 15% by volume, preferably of 1 to 12% by volume, further preferably of 1 to 10% by volume, and particularly preferably of 1 to 8% by volume. The other portion of the respective drying gas flow consists essentially of nitrogen and water vapour.

This cycle gas enriched with water vapour and CO₂ and depleted in oxygen enables particularly safe operation under the substance-specific minimal oxygen threshold concentration of the substance systems used in each case. This also enables the use of motor-driven integrated impact tools for the reduction of the granule size and for the compaction of the granules.

Surprisingly, it has been found that using this mode of operation, in spite of the higher process temperature necessary for drying, the formation of dark (black) particles and coatings in the granulation chamber can be completely avoided. Thus the interruption-free operation of the plant up to the next maintenance or cleaning cycle can at least be doubled.

Advantageously, the drying gas flows through the chamber against gravitational force and is introduced into the granulation chamber via a distributor plate. The granulation can be carried out in the process according to the invention in a stationary fluidized bed. Alternatively, the granulation can be carried out in a circulating fluidized bed (CFB). This means that the inflow velocity of the drying gas flow is adjusted such that 75 to 100% by weight, preferably 85 to 100% by weight, in particular 95 to 100% by weight, of the solid particles, based on the fluidized bed in the granulation chamber, continuously leave this chamber upwards, then are separated from the gas flow and returned to the granulation chamber.

The inflow rate necessary for discharge is dependent on the particle size and the density of the particles and amounts in general to 1 to 10 times, preferably 1 to 4 times, the rate which is necessary also to be able to circulate particles, which do not belong to the fine dust (<100 μm), in the desired amount with the drying gas flow. These are in particular particles which have still not achieved the desired final size. In the present process, particles having grain sizes <and >100 μm, if desired also in the range from 250 μm to 600 μm, are conveyed upwards and circulated in the desired amount.

The circulation rate per hour in general corresponds to 2 to 100 times, in particular to 5 to 50 times, the mass hold-up in the granulation chamber.

As already explained above, the process according to the invention is particularly suitable for the production of granules from aqueous solutions or suspensions containing amino acids. In a particularly preferred process, the amino acid which is comprised in the aqueous suspension or in the aqueous solution has a solubility in water of less than 90 g/l at 20° C. It is particularly preferred here that the amino acid which is contained in the aqueous suspension or in the aqueous solution is selected from the group consisting of L-lysine, L-methionine, L-threonine, L-tryptophan and L-valine.

The amino acid can typically be contained to at least 5% by weight, preferably to 10, 15, 20, 25, 30, 35, 40, 45, 50, 55, 60, 65 or 70% by weight in the aqueous suspension or aqueous solution sprayed in the granulation chamber. In particular, it is preferred that the amino acid is contained in the aqueous suspension or aqueous solution sprayed in the granulation chamber to at least 20, 25, 30, 35, 40, 45, 50, 55, 60, 65 or 70% by weight.

The liquids to be sprayed employed in the granulation chamber are either concentrated aqueous solutions or suspensions containing purified compounds from chemical and fermentative production having a purity of the solid of 5 to about 99.5%, and also concentrated fermentation broths. As in EP 0 809 940 B1 and EP 615 693 B1, the fermentation broths contain, if appropriate, still further constituents of the fermentation broth as well as the biomass in addition to the desired amino acids. The biomass, however, can also already be completely or partially separated off.

Using the process according to the invention, high build-up rates and thus an efficient process can be realized even for particles having a relatively small average diameter of, for example, 100 to 400 μm with the solids mentioned. Even particles in the size range smaller than 100 μm can be accessible by means of a fluidized bed spray granulation.

The efficiency of the process is also dependent on the content of the solid in the feed solution. With increasing solids content, the amount of water to be evaporated falls. The energy requirement necessary for the granulation is reduced.

For relatively poorly soluble amino acids (for example L-methionine, L-threonine, L-tryptophan and L-valine: solubility at 85° C. about 19%; at 120° C. about 32%), an increase in the solubility and thereby the efficiency of the process can preferably be performed by superheating. Using a special nozzle arrangement, a preliminary pressure of 1 to 5 bar in the supply line to the nozzles is produced, which enables heating to over 100 to 160° C. The special binary pressure nozzle operated using compressed air has an extended liquid insert with a three slot spinner body. The spinner body is dimensioned and adjusted such that the free cross-section, through which the liquid has to pass, is as large as possible and despite this a high pressure drop of up to 5 bar under operating conditions is achieved in the liquid line. At the same time, despite this accumulation in the fluid, solid particles contained having a particle size up to 50 μm can pass through the nozzle. The atomization of the liquid passing through the spinner body takes place pneumatically by releasing compressed air in the annular gap around the liquid insert.

The increase in the solid concentration can also be carried out by the use of suspensions of the appropriate solid in a saturated solution of the appropriate solid. These can be produced by overconcentration of a solution containing the solid by evaporation etc. When using suspensions, a small particle size (in general 10-30 μm) of the undissolved solid fraction offers advantages in the production of stable granules. If necessary, the particle size of the undissolved fraction can correspondingly be reduced by prior dry milling of the added solid fraction or a wet grinding in the suspension, preferably by means of only one passage through the grinding organ in the supply line to the spray nozzle.

Using the process described, it is possible to process suspensions having solid concentrations up to over 70% by weight, it being possible for the solids to be present dissolved or undissolved in the suspension. Suspensions having a content of 25 to 60% by weight, based on the total amount of the suspension, are preferably employed. Using the process described, granules having the required properties can be produced from solutions or suspensions of very pure solids (up to 99.5%) without addition of binders or other auxiliaries.

In processes according to the prior art, it was hitherto necessary to add binders or adhesives such as, for example, starch or celluloses for improving the tendency to granulate. Using the process described, it is possible to granulate highly concentrated, amino acid-containing solutions and suspensions, without the said addition of binders or adhesives or with a 35%, preferably 50% and particularly preferably 65% reduced addition amount. Customarily, binders are added in the range of up to 5% by weight. The purity can be significantly improved by the process according to the invention. Thus, for the granulation according to the invention, binders or adhesives such as, for example, starch or celluloses are added for improving the granulation tendency. Examples of binders or adhesives include the following: in particular, acetylated oxidized starch, acetylated starch, acetylated distarch adipate, acetylated distarch phosphate, agar agar, alginic acid, bentonite, carrageenan, cellulose derivatives, cellulose acetate, cellulose acetate phthalate, cellulose acetate succinate, cellulose methophthalate, dextrans, dextrins, distarch phosphate, egg yolk, ethylcellulose, Eudispert®, Eudragit®, gelatine, gellan, guar flour, gum arabic, hydroxypropylcellulose, hydroxypropylglycerol, hydroxypropylstarch, hydroxypropylstarch phosphate, hypromellose phthalate, carob bean flour, potassium alginate, karaya, Kelacid®, Kelcosol®, Keltose®, Klucel®, Kollidon®, Kolloidon®, lactose, lecithins, lignins, lignin sulphates, lignin sulphonates, Lucidal®, maize starch powder, maltodextrin, mannans, flour butter, roux, methyethylcellulose, methylcellulose, setolose, monostarch phosphate, sodium alginate, sodium carboxylmethylcellulose, Oppanol®, oxidized starch, pectin, arrowroot flour, phosphated distarch phosphate, Plasdone®, polyacrylamide, polyvinyl acetate, polyvinyl acetate diethylaminoacetate, polyvinyl acetate phthalate, polyvinyl alcohol, polyvinylpyrrolidone, pullulan, sago, silicon resins, starch, starch sodium octenylsuccinate, stearic acid, stealyl alcohol, Surelease®, tara stone flour, tragacanth, water glass, xanthan and celluloses. Preferably, the total amount of such binders or adhesives is restricted to below 4% by weight, further preferably below 3% by weight, particularly preferably below 2.5% by weight, particularly preferably below 2.0% by weight, in particular below 1.5% by weight, further preferably below 1.0% by weight, even further preferably below 0.8% by weight, particularly preferably below 0.5% by weight in the granules obtained. Very particularly preferably, these binders or adhesives are completely omitted.

In a variation of the process according to the invention, the addition of binders or adhesives to the aqueous suspension or aqueous solution sprayed in the granulation chamber is therefore adjusted so that its proportion in the granules obtained is below 4% by weight, further preferably below 3% by weight, particularly preferably below 2.5% by weight, particularly preferably below 2.0% by weight, in particular below 1.5% by weight, further preferably below 1.0% by weight, even further preferably below 0.8% by weight, particularly preferably below 0.5% by weight, and very particularly preferably no binders or adhesives are added.

In a further embodiment, the process according to the invention for the production of the granules is operated such that the average particle size of the granules can be adjusted to values between >0.1 and 2.0 mm. Preferably, the diameter of 95% of the particles is in the range between >0.1 and 1.2 mm. Moreover, it is particularly expedient if the diameter of the particles is adjusted such that it is in the range between 0.3 and 0.8 mm in 95% of the particles. In a further variant of the process according to the invention it is preferred that the diameter in 95% of the particles is in the range between 0.5 and 1.2 mm.

The bulk density of the granules obtained is preferably adjusted to >600 kg/m³ to 700 kg/m³. In a still further expedient process modification, the invention can be carried out such that the bulk density of the animal feed additive is adjusted to >650 kg/m³ to 800 kg/m³ in a single step.

The resistance to abrasion and the breaking strength are often strongly dependent on the chemical substance system that is to be granulated. The process according to the invention leads to a significant improvement in the values of 25% or more. Further preferably, the resistance to abrasion of the granules obtained by the process according to the invention exhibits abrasion values in the range of <2.0% by weight, preferably <1.0% by weight, further preferably <0.5% by weight, particularly preferably <0.4% by weight and very particularly preferably an abrasion between 0 and 0.3% by weight.

With the process according to the invention granules are obtainable having irregular agglomerate-like morphology or alternatively having essentially spherical habit as well as enveloped granules, the granules or the envelope consisting of one or more organic or inorganic compounds. The granules are distinguished by good application technology properties such as, for example, freedom from dust and resistance to abrasion. For the determination of the resistance to abrasion a sample is taken from the granules to be determined and the fine fraction is screened out therefrom (i.e. particles smaller than the average grain size D50 [50 μm] are removed). The sample is put into an Erweka Friabulator [friability tester] (ERWEKA GmbH, Heusenstamm/Germany). The granules are then treated under the following test conditions: 20 revolutions/minute and 20 minutes' stress. This test is a combined abrasion and case stress. After this treatment, the fine fraction is determined again. The fine fraction resulting due to the stress represents the abrasion. The abrasion is the measure of the resistance to abrasion: the lower the amount of abrasion, the higher is the resistance to abrasion of the granules.

As already mentioned, according to the invention the granule properties such as abrasion and breaking strength compared to a granulation not in accordance with the invention with respect to granules containing amino acids and optionally constituents of the fermentation broth for use as feed additives were improved by 25% or more.

In addition, the process according to the invention makes available granules comprising L-methionine, L-threonine, 1-tryptophan, or L-valine in an amount of about 20 to 50% by weight, 0 to 3% by weight of a binder and optionally constituents of the fermentation broth for use as feed additives.

The process according to the invention makes available granules comprising L-methionine and optionally constituents of the fermentation broth for use as feed additives, the fraction of L-methionine in the granules being at least 25% by weight and the strength of the granules according to the shear test being up to 35% by weight, preferably up to 25% by weight, further preferably up to 20% by weight, in particular preferably up to 25% by weight and particularly preferably up to 12% by weight;

the abrasion being measured with a Schulze ring shear cell RST-XS using the following parameters: granules having particle sizes of 250 μm and more; applied load stress of 30000 Pascals; shear path of 500 mm; the fraction <250 μm obtained being indicitated as the strength value according to the shear test.

In the strength determination using the Schulze ring shear cell RST-XS, the granules to be measured are screened out at 250 μm and the coarse fraction is used for the measurement. The measuring volume of the cell is completely filled with granules, the shear lid is fitted and loaded with a load stress of 30000 Pascals using a hanger. During the shear stress, the lower part of the shear cell rotates. The shear path is 500 mm. After the stress, the sample is removed and screened again at 250 μm. The fraction <250 μm is specified as the strength value according to the shear test. The smaller this value turns out, the stronger and more stressable are the granules.

The process according to the invention makes available granules comprising amino acids in an amount of at least 25% by weight and optionally constituents of the fermentation broth for use as feed additives, having an extraordinary abrasion resistance and an excellent granule strength.

The abrasion can be measured with an Erweka Friabilator using the following parameters: 50 g of granules, 20 min stress period, 20 rpm, 50 μm screen, the fraction obtained <50 μm being indicated as a measure of the resistance to abrasion.

For the determination of the granule strength, a Zwick strength testing machine (Material testing 1446) having a load cell F61290 from Hottinger Baldwin Messtechnik is preferably used; a piston driving with constant advance onto the inserted granule, and the granule breaking; the last applied thrust force of the piston being specified as a measure of the granule strength.

The invention is directed at a process for the production of granules in a fluidized bed, a suspension comprising an amino acid being sprayed from a fermentation onto particles situated in the fluidized bed having a smaller mean diameter than that of the particles to be produced and simultaneously water contained in the medium being evaporated. The drying gas necessary for the maintenance of the fluidized bed and for the substance and heat transport is preferably recycled (cycle gas). The energy-producing combustion of natural gas and the direct use of the hot gas flowing off from the burner lead to the desired depletion of oxygen and simultaneously to the enrichment of CO₂ and water vapour in the cycle gas. The cycle gas flowing back is not completely condensed out according to the invention, so that the water vapour loading of the cycle gas is already increased at the entry to the drying process. A typical composition of the cycle gas used at the dryer entry is 10% CO₂, 12% O₂, 6% water vapour and the remainder essentially nitrogen. The process is in particular directed at the production of amino acid-containing granules, which consist of amino acids soluble to different extents in water, such as, for example, L-lysine, L-methionine, L-valine, L-threonine and L-tryptophan.

Hans Uhlemann, Chem.-Ing.-Tech.62 (1990), pages 822-834 gives an overview of known processes and apparatuses for fluidized bed spray granulation. Essential features of fluidized bed spray granulation are the formation of a stable fluidized bed within a granulator(=reactor), the spraying of the liquid medium, which contains granule-forming material in the form of a solution, a suspension or melt, onto the particles of the fluidized bed and the evaporation of the solvent contained in the liquid medium taking place at the same time. During the fluidized bed spray granulation, the particles grow and particles of the desired target grain size are separated off in a suitable manner from the fluidized bed. Fine particles separated off by the fluidized bed gas are recycled to the process in a suitable manner. Uhlemann teaches different process variants, measures for the injection of a liquid medium into the fluidized bed, for the dedusting of the waste air and also for the control of the granule moisture and granule size. In all embodiments of Uhlemann heated air is always used as the fluidized bed gas, which serves for fluidization and at the same time is an energy carrier.

In Chemische Produktion (Chemical Production) 6/92, pages 18-21, the principle of action of a continuous fluidized bed granulation dryer is shown, which apart from drying is also suitable for the agglomeration of pulverulent substances, for the coating of disperse granular substances as well as for carrying out chemical reactions between solid and fluid phases. As a drying medium, as a rule hot air, but also hot gas, is supplied to the drier by means of a specially designed distributor plate. For intensification of the heat transfer, a part of the waste air can be recirculated to the heat exchanger as environmental air in recirculated air operation and is available to the reactor again as a drying medium. According to an alternative embodiment, the waste air emerging from a fluidized bed spray granulator is used for the preheating of fresh air used as a drying medium.

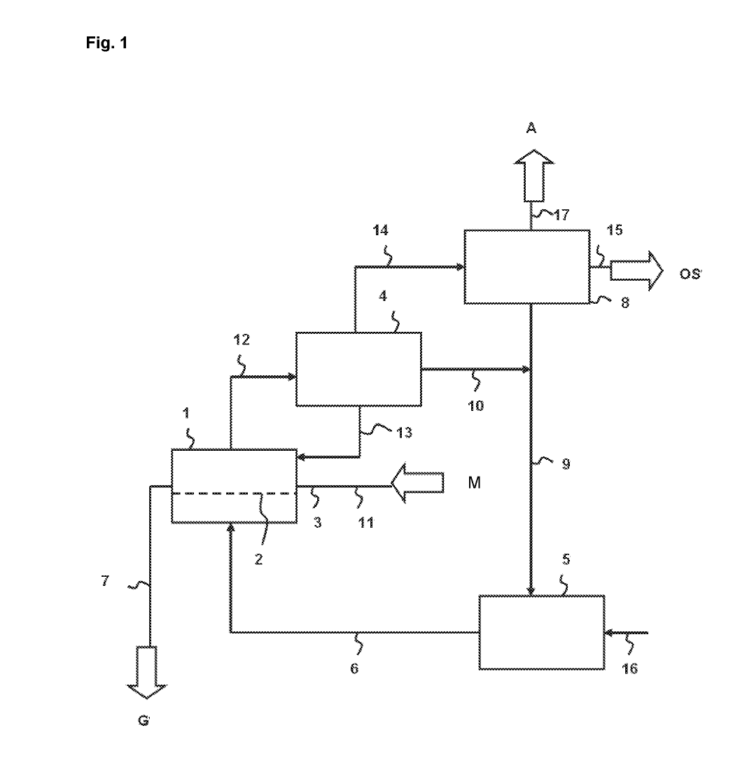

The implementation of the process according to the invention is illustrated with the aid of FIG. 1, which shows a scheme of a fluidized bed spray granulation device.

The apparatus comprises a fluidized bed reactor (1), a solid/gas separating device for dust elimination (4), an apparatus for the at least partial condensation of the water vapour (8) contained in at least one partial stream of the fluidized bed waste gas and an apparatus for warming the fluidized bed gas (5) and also the lines between the individual apparatuses shown in the Figure. The fluidized bed reactor contains in its lower part a distributor plate (2), through which the fluidized bed gas (drying gas) introduced into the lowest part of the reactor by means of a line (6) flows in a form uniformly distributed over the distributor plate, in order to keep the particulate material in the reactor in a stationary or in a circulating fluidized bed. Within the fluidized bed reactor are arranged one or more spray nozzles (3), through which the liquid medium (M) is supplied by means of a line (11). The reactor comprises an apparatus for the discharge of the granules (G), which is constructed in the figure as a simple line (7). The reactor itself can be constructed in a known manner, for example as a circular reactor or as a flow channel.

The actual granulation chamber of the fluidized bed reactor is generally of cylindrical design in the lower part in the case of a round type of design, the ratio of diameter to height usually being in the range from 1 to 1 to 1 to 5, preferably 1 to 2.5. To this cylindrical part, in which essentially the fluidized bed is situated, is connected the expansion space having an upwardly increasing diameter. Also in the case of a flow channel-like reactor, the fluidized bed is situated in a lower part with vertical walls, and thereto is connected an upper, widening part as an expansion space. At the upper end of the granulation chamber, the fluidized bed gas is led by means of a line (12) into a means for solid/gas separation (4), in which fine particles (dust) are deposited. This apparatus is known equipment, such as exhaust filters and cyclones. If necessary, one or more cyclone separators are connected in series and optionally a waste air filter is connected downstream. The solid separators are provided with one or more solid recirculation lines (13), by means of which the dust is again returned to the fluidized bed reactor. For the pneumatic closure of the solid separator(s)—this embodiment is in particular necessary in a fluidized bed reactor with a circulating fluidized bed—customary apparatuses, such as rotary feeders, are employed.

The fluidized bed waste gas freed from solid fractions is conducted at least partially by means of a line (14) into an apparatus (8) for the condensation of the water vapour contained in the waste gas. In the condensation apparatus, at least a part of the water vapour is condensed by means of a cooling medium. The condensed water vapour is discharged by means of a line (15). In the cycle gas circulation, the residual gas from the condensation apparatus is supplied by means of a line (9) of an apparatus for the heating of the fluidized bed gas. The latter arrives from there via a line (6) in a chamber arranged below the distributor plate, which enables a uniform inflow of the fluidized bed gas over the entire cross-section of the fluidized bed reactor.

From the fluidized bed reactor, the granules obtained are removed from the fluidized bed chamber continuously or periodically by means of a suitable removal device—shown in the Figure as a simple removal line (7). Expediently, this removal device is a customary classifier. The classifier gas used can be an inert gas or preferably superheated circulation gas.

The apparatus for heating the fluidized bed gas can be designed in any desired manner. For example, the gas can be heated electrically and/or in a heat exchanger using suitable heating media. In particular, nitrogen (N₂) can be used as the fluidized bed gas when starting the apparatus according to the invention, which is supplied via a line (16) to the apparatus (5) for the heating of the fluidized bed gas. In the starting phase, the excess waste gas (A) is discharged from the cycle process via a line (17). According to a preferred embodiment, namely the cycle gas circulation, a part of the dedusted fluidized bed waste gas is conducted directly into a circuit line (9) via a line (10).

Further, a particularly preferred embodiment is the direct flue gas utilization of burnt natural gas and the cycle gas circulation described above. By this means, the atmospheric oxygen can be reduced without use of expensive inert gases such that dust-explosive products can be safely processed. Relatively high entry temperatures are easy to realize. Further, this leads to the fact that an increased concentration of CO₂ and water vapour is already present in the gas flowing into the fluidizing chamber. By means of the condensation temperature in the cycle gas, the concentration of water vapour in the cycle gas flowing back can further be selectively influenced.

In this embodiment, integrated motor-driven impact tools can be employed for the adjustment of the granule size and for the compaction of the granules, although they are otherwise to be regarded as potential sources of ignition.

Furthermore, in this embodiment in comparison to the conventional prior art, higher process temperatures are necessary for the drying of the granules. Nevertheless, the formation of dark (black) deposits and particles is completely avoided.

Further, a particularly preferred embodiment is drying in the superheated steam in cycle gas circulation. Thereby the atmospheric oxygen can likewise be reduced without use of expensive inert gases such that dust-explosive products can be processed. Relatively high entry temperatures are easy to realize. This further leads to the fact that the gas flowing into the fluidizing chamber essentially consists of water vapour. In the main flow of the circulation process steam is not condensed in this variant. The excess vapour is discharged and is available for downstream use.

The granulation of aqueous suspensions or aqueous solutions containing different water-soluble amino acids, such as L-lysine, L-methionine, L-threonine, L-tryptophan, and L-valine, in a granulation plant with recycling succeeds better under conditions more unfavourable for the actual drying. With the process according to the invention, high-strength granules stable to abrasion and having improved properties can be produced using concentrated suspensions of differently water-soluble amino acids from fermentation processes.

The granulation of solids in the stationary and circulating fluidized bed (CFB) takes place in the manner described below. Here, the inflow velocity of the hot drying gas in the granulation chamber is preferably markedly above the discharge velocity of the granulated particles.

Using the nozzle, a solid-containing suspension or solution is sprayed into the granulation chamber operated with hot drying gas and either still solid-free or already provided with a starting filling of fine particles. The liquid evaporates there and solids remain. The particle flow forming in the granulation chamber is discharged to 100% from this chamber, then deposited, for example, with the aid of cyclones and recycled into the chamber. This preferably takes place with a very high circulation rate. Preferred circulation rates are 2 to 100-fold, particularly preferably 5 to 50-fold, of the mass-hold-ups in the granulator per hour.

In order to have sufficient spray nuclei for the absorption of the suspension droplets in this circulating mass, it is necessary to maintain an adequate mass hold-up in the system, which is accompanied by a high circulating mass flow. The layout of the solid deposition of the waste gas flow is to be adapted to this high throughput.

A pressure loss measurement, for example, via the first cyclone can be employed as a measure of the circulating mass flow. With higher solid loading, the pressure drop via the cyclone increases under otherwise identical operating conditions. If the cyclone is overloaded and breaks apart, the differential pressure then reaches a maximal value not increasing further. The operating point to be strived for is somewhat below this level.

In the upward flow of the drying chamber, the recycled solid is conveyed upwards past the nozzle. In the nozzle jet, solid particles and spray droplets meet. The liquid dries off on the surface of the particles, and the solid contained remains. Thereby the particles in the circulation layer grow. In order to achieve granules as spherical as possible, the spray droplets must be significantly smaller than the granules conveyed in the cycle.

The circulating mass must be kept constant, so that after the build-up of a sufficient mass hold-up in the granulator a part of the mass situated therein can be continuously discharged. By withdrawal of the gas flow of the integrated classifier, only the coarse particles are discharged and the fine material remains for further granule build-up in the granulator. The classifier is controlled such that the mass circulating in the system remains constant.

The grain size to be achieved in the discharge is dependent on the nucleus balance in the granulator. This is essentially determined from the equilibrium of seed formation by abrasion or non-impinging spray droplets and the granule build-up. The grain size can be increased selectively on the one hand by the choice of the drying parameters or on the other hand by addition of binder.

Thus different drying parameters can be adjusted by the increase in the feed amount. The waste air temperature thereby falls and more spray droplets are produced, which dry more slowly. Thus the hit probability on the granule seeds increases; in addition the granule surface remains moist for longer. On average larger seeds are formed.

Preferably, the process according to the invention is operated for the production of granules for use as a feed additive such that the average particle size of the animal feed additive is adjusted to values between >0.1 and 2.0 mm. Preferably, the diameter of 95% of the particles is in the range between >0.1 and 1.2 mm. Moreover, it is particularly expedient if the diameter of the particles is adjusted such that it is in the range between 0.3 and 0.8 mm in the case of 95% of the particles. In a further variant of the process according to the invention the diameter in the case of 95% of the particles is in the range between 0.5 and 1.2 mm.

By the process according to the invention, a product having a desired bulk density is obtained from a fermentation broth which is preferably thickened and can be partly or completely freed from biomass or in the original state. Here, the bulk density of the animal feed additive is preferably adjusted to >600 kg/m³ to 700 kg/m³. In a still further expedient process modification, the invention can be carried out such that the bulk density of the animal feed additive is adjusted to >650 kg/m³ to 800 kg/m³ in a single step.

In addition, animal feed additives having outstanding abrasion resistance of the granules can be obtained by the process according to the invention. Thus it is easily possible with suitable process management to adjust the abrasion resistance of the animal feed additive to abrasion values in the region of <2.0% by weight. Particularly preferably, the process of the invention is conducted such that the abrasion resistance of the animal feed additive is adjusted to an abrasion of <1.0% by weight, further preferably <0.5% by weight, particularly preferably <0.4% by weight and very particularly preferably between 0 and 0.3% by weight.

Customarily, the dry additives accessible according to the invention contain up to 20% fermentation biomass.

### EXAMPLES

### Example 1

### Determination of the Dry Biomass Content of the Fermentation Broths

The dry biomass includes all substances which the microorganisms contain excluding water. For the determination of the dry biomass, the dissolved substances contained in the nutrient solution and the biomass are therefore separated from one another and the moist biomass is dried by evaporation of the water. For the determination of the dry biomass content of the fermentation broths or of the solutions which are to be employed in the process according to the invention for the production of granules, the microorganisms were first inactivated at a temperature of 90° C. after the end of the fermentation. A sample of the fermentation broth was subsequently subjected to an ultrafiltration. The retentate constitutes the biomass of the sample of the fermentation broth. The dry biomass content in the fermentation broth was determined by drying the retentate on an infrared balance.

### Example 2

### Determination of the Resistance to Abrasion

For the determination of the resistance to abrasion, a sample of 50 g was removed from the granules to be determined and the fine fraction was screened off therefrom (i.e. particles smaller than the average grain size D 50 are removed using a 50μm screen). The sample was put into an Erweka Friabulator (ERWEKA GmbH, Heusenstamm/Germany). The granules were treated using the following test conditions: 20 revolutions/minute and 20 minutes' stress. It was a matter here of a combined abrasion and gravity stress. After the treatment, the fine fraction was determined again (50 μm screen). The fine fraction resulting due to the stress represents the abrasion. The lower the amount of abrasion, the higher the resistance to abrasion of the granules.

### Example 3

### Granule Strength

For the determination of the granule strength, the Zwick strength testing machine (Zwick material testing 1446) having a weighing cell F61290 from Hottinger Baldwin Messtechnik was used. The machine drives using the piston with constant advance on the inserted granule. One granule grain is used here. When the granule breaks, the last applied forward force of the piston is indicated. At least 20 granules were tested and the result indicated as a mean value.

### Example 4

### Determination of the Grain Size Distribution

The grain size distribution was measured by means of dynamic image analysis using the Retsch Camsizer (RETSCH GmbH, Haan/Deutschland). The sample to be measured was put into the metering device. The metering was adjusted such that the granules pass the camera system in isolated form. All particles of the sample were measured and indicated as a data set and distribution curves.

### Example 5

### Determination of the Bulk Density

The measurement of the bulk density is based on the determination of the mass in a defined volume of pulverulent or granulated substances.

The determination of the bulk density of the granules was performed as follows: firstly, the weight of an empty 250 ml cylinder was measured on the laboratory balance. The measuring cylinder was then placed below the closed opening of a funnel which possessed a somewhat larger capacity than the measuring funnel. The funnel was then completely filled with the granules to be tested. The funnel was then opened and the measuring cylinder standing below was completely filled with granules, a small excess of granules being present. After this, the supernatant part of the granules was scraped off from the measuring cylinder with a scraper such that a constantly correct volume of 250 ml was achieved. Finally, the measuring cylinder completely filled with granules was weighed on the laboratory balance and the amount of granules contained was calculated from the measured values and the bulk density of the granules was stated as the quotient mass/volume in kg/m³.

### Example 6

### Determination of the Strength by Shear Test

The determination of the strength using the Zwick apparatus cannot be carried out with relatively small granules. Therefore a strength determination using the Schulze ring shear cell RST-XS was alternatively used. The granules to be measured were screened out at 250 μm and the coarse fraction was used for the measurement. The measuring volume of the cell was completely filled with granules, the shear lid was fitted and loaded with a load stress of 30000 Pascals using a hanger. During the shear stress, the lower part of the shear cell rotates. The shear path was 500 mm. After the stress, the sample was removed and screened again at 250 μm. The fraction <250 μm was indicated as the strength value according to the shear test. The smaller this value turns out, the stronger and more stressable are the granules.

### Example 7

### L-Methionine (L-methionine Containing By-Products (BP) and Biomass)

An L-methionine-containing fermentation broth from an experimental fermenter was to the greatest extent freed of the biomass by means of ultrafiltration. Two valuable substance-containing solutions were obtained, the parameters of which are shown in the following Tables 4 and 5:

TABLE 4
1. Solution with biomass containing:

1.7% by weight of L-methionine
0.9% by weight of by-products
26.7% by weight of dry biomass
70.7% by weight of water

TABLE 5
2. Solution with L-methionine containing:

12% by weight of L-methionine
6.1% by weight of by-products
0.9% by weight of dry biomass
80.1% by weight of water
0.9% by weight of maize starch as an adhesive additive

Both solutions were sprayed onto 1800 g of L-methionine starting granules having an average grain size of <240 μm in a laboratory fluidized bed by means of fluidized bed spray granulation. The mixture was sprayed on until 1800 g of solid had been sprayed again. After spraying on, brief afterdrying was carried out in all experiments.

The solid parameter adjustments were as follows: volume flow 40 m³/h of nitrogen and 172° C. nitrogen entry temperature. The steam addition and, by means of the spray rate, the fluidized bed temperature were selectively varied. Thus a relative humidity of the gases flowing off of 4.5 to 42% was obtained.

The process parameters and the yields of the granules obtained are summarized in the following Tables 6 and 7. Here, the experiments 1 to 9 (Table 6) with biomass solution and the experiments 10 to 18 (Table 7) with methionine have been carried out with adhesive, i.e. with binder addition. The temperature (2nd column) was measured in the centre of the fluidized bed.

TABLE 6
Process parameters and properties of the granules containing L-methionine with biomass

| | | | | | | abs. | rel. | | | | | Strength | |
|---|---|---|---|---|---|---|---|---|---|---|---|---|---|
| | | Steam | | | Steam | humidity | humidity | | | | | shear | |
| Ex. | Temp. | addition | V flow | Temp. | addition | waste gas | waste gas | RF | D10 | D50 | D90 | test* | Abrasion** |
| No. | [° C.] | [g/kg] | [m³/h] | [° C.] | [kg/h] | [kg/kg] | [% rel. h] | [%] | [μm] | [μm] | [μm] | [%] | [%] |
| 1 | 82 | 0 | 40 | 172 | 0 | 0.0144 | 4.5 | 0.17 | 170 | 321 | 532 | 33 | 53 |
| 2 | 67 | 0 | 40 | 172 | 0 | 0.0168 | 9.7 | 0.25 | 235 | 448 | 735 | 21 | 47 |
| 3 | 54 | 0 | 40 | 172 | 0 | 0.0189 | 19.9 | 0.20 | 317 | 639 | 1124 | 15 | 36 |
| 4 | 96 | 30 | 40 | 172 | 1.3 | 0.0382 | 6.7 | 0.25 | 222 | 425 | 672 | 23 | 53 |
| 5 | 80 | 30 | 40 | 172 | 1.3 | 0.0407 | 13.1 | 0.16 | 319 | 620 | 1098 | 17 | 36 |
| 6 | 65 | 30 | 40 | 172 | 1.3 | 0.0431 | 26.3 | 0.13 | 451 | 895 | 1564 | 12 | 24 |
| 7 | 106 | 60 | 40 | 172 | 4.3 | 0.0966 | 10.9 | 0.20 | 247 | 525 | 914 | 19 | 47 |
| 8 | 88 | 60 | 40 | 172 | 4.3 | 0.0994 | 21.5 | 0.25 | 399 | 893 | 1788 | 14 | 32 |
| 9 | 72 | 60 | 40 | 172 | 4.3 | 0.1020 | 42.0 | 0.16 | 465 | 1073 | 2093 | 11 | 18 |

*Schulze ring shear cell RST-XS, load stress 30000 Pascal, shear path 500 mm, 250 μm screen
**Erweka Friabulator, 50 g, 20 min, 20, 20 rev/min, 50 μm screen

TABLE 7
Process parameters and properties of the granules containing L-
methionine with binder, biomass for the most part separated off

| | | | | | | abs. | rel. | | | | | Strength | |
|---|---|---|---|---|---|---|---|---|---|---|---|---|---|
| | | Steam | | | Steam | humidity | humidity | | | | | shear | |
| Ex. | Temp. | addition | V flow | Temp. | addition | waste gas | waste gas | RF | D10 | D50 | D90 | test* | Abrasion** |
| No. | [° C.] | [g/kg] | [m³/h] | [° C.] | [kg/h] | [kg/kg] | [% rel. h] | [%] | [μm] | [μm] | [μm] | [%] | [%] |
| 1 | 82 | 0 | 40 | 172 | 0 | 0.0144 | 4.5 | 0.12 | 158 | 298 | 502 | 36 | 55 |
| 2 | 67 | 0 | 40 | 172 | 0 | 0.0168 | 9.7 | 0.13 | 215 | 428 | 715 | 29 | 49 |
| 3 | 54 | 0 | 40 | 172 | 0 | 0.0189 | 19.9 | 0.18 | 317 | 629 | 1236 | 22 | 39 |
| 4 | 96 | 30 | 40 | 172 | 1.3 | 0.0382 | 6.7 | 0.14 | 192 | 335 | 561 | 33 | 51 |
| 5 | 80 | 30 | 40 | 172 | 1.3 | 0.0407 | 13.1 | 0.17 | 309 | 612 | 1123 | 23 | 43 |
| 6 | 65 | 30 | 40 | 172 | 1.3 | 0.0431 | 26.3 | 0.23 | 409 | 890 | 1566 | 19 | 34 |
| 7 | 106 | 60 | 40 | 172 | 4.3 | 0.0966 | 10.9 | 0.16 | 253 | 535 | 944 | 25 | 47 |
| 8 | 88 | 60 | 40 | 172 | 4.3 | 0.0994 | 21.5 | 0.20 | 356 | 635 | 1353 | 20 | 37 |
| 9 | 72 | 60 | 40 | 172 | 4.3 | 0.1020 | 42.0 | 0.26 | 421 | 856 | 1699 | 18 | 22 |

*Schulze ring shear cell RST-XS, load stress 30000 Pascal, shear path 500 mm, 250 μm screen
**Erweka Friabulator, 50 g, 20 min, 20, 20 rev/min, 50 μm screen

From the results, it can be concluded that the higher the relative humidity of the gas flowing from the fluidized bed, the more the particle size distribution is shifted to coarseness and the strength of the granules is increased while the abrasion values are decreased.

### Example 8

### L-Lysine Containing By-Products and Biomass

The granule parameters of L-lysine granules from continuous production according to the present invention were compared with L-lysine granules produced in a laboratory granulator. The starting material used for both granules was the same fermentatively produced L-lysine-containing broth, which had the parameters listed in Table 8:

TABLE 8
fermentatively produced L-lysine-containing broth

37% by weight of L-lysine sulphate
10% by weight of by-products
6% by weight of dry biomass
47% by weight of water

The production process according to the invention was a cycle gas process, in which cycle gas saturated at >30° C. was recycled into the granulator again. The entry moisture loading of the drying gases was increased still further by the combustion chamber. The drying gases flowing off from the fluidized bed chamber had a relative humidity of more than 20%. In contrast to this, the granulator in the comparative example was supplied with absolutely dry nitrogen. The drying gas flowing off had <8% relative humidity.

The granules thus obtained were investigated for their properties and the results summarized in Tables 9 and 10.

TABLE 9
L-lysine cycle gas sample (according to the invention)

| Bulk density | 665 | kg/m³ |
|---|---|---|
| Strength* | 7.2N | |
| Abrasion** | 0.58% | |
| D 10% | 542 | μm |
| D 50% | 989 | μm |
| D 90% | 1436 | μm |

*Zwick strength testing machine (Material testing 1446; weighing cell F61290)
**Erweka Friabulator, 50 g, 20 min, 20, 20 rev/min, 50 μm screen

TABLE 10
L-lysine laboratory sample (comparison example)

| Bulk density | 532 | kg/m³ |
|---|---|---|
| Strength* | 3.2N | |
| Abrasion** | 3.65% | |
| D 10% | 342 | μm |
| D 50% | 789 | μm |
| D 90% | 936 | μm |

*Zwick strength testing machine (Material testing 1446; weighing cell F61290)
**Erweka Friabulator, 50 g, 20 min, 20, 20 rev/min, 50 μm screen

Here too, the results show that the granules obtained by the process according to the invention (Table 9) had a higher granulation strength and a higher resistance to abrasion than the comparison granules (Table 10).

### Example 9

### L-Valine with By-Products and Biomass

In this Example and in Example 10, samples that were produced using a laboratory granulator in open waste gas operation were compared with samples that were produced in a pilot cycle gas plant according to the present invention. The specifications and parameters of the apparatuses and of the process were as shown in Table 11 below:

TABLE 11
Laboratory granulator (comparison example)

| | | |
|---|---|---|
| diameter | 200 | mm |
| dry nitrogen | 180° | C. |
| fluidized bed temperature | 65° | C. |
| fluidizing gas amount | 40 | m³/h |

| | |
|---|---|
| relative waste gas humidity | <8% |

Cycle gas plant (according to the invention)

| diameter | 400 | mm |
|---|---|---|
| cycle gas | 280° C. saturated with | |
| | water at 35° C. | |
| water vapour loading | 0.036 | kg/kg |
| cycle gas at the entrance | | |
| fluidized bed temperature | 75° | C. |
| amount of fluidized gas | 450 | m³/h |

| | |
|---|---|
| relative waste gas humidity | >25% |

An L-valine-containing fermentatively produced solution (containing 13% by weight of L-valine was converted into a solid by means of fluidized bed spray granulation according to the two processes described above. The fermentatively produced broth had the parameters listed in Table 12:

TABLE 12
fermentatively produced L-valine-containing broth

9.3% by weight of L-valine
1.3% by weight of by-products
5.4% by weight of dry biomass
84% by weight of water

As starting granules, comminuted valine granules were employed. The granules produced according to the different processes were investigated and the results obtained were summarized as in Tables 13 and 14:

TABLE 13
Granules according to process 1 (laboratory
granulator; comparison example)

| | |
|---|---|
| Strength* | 2.0N |
| Abrasion** | 4.3% |
| D 10% | 304 μm |
| D 50% | 691 μm |
| D 90% | 1119 μm |

*Zwick strength testing machine (Material testing 1446; weighing cell F61290)
**Erweka Friabulator, 50 g, 20 min, 20, 20 rev/min, 50 μm screen

TABLE 14
Granules according to process 2 (cycle
gas plant; according to the invention)

| | |
|---|---|
| Strength* | 5.9N |
| Abrasion** | 1.4% |
| D 10% | 902 μm |
| D 50% | 1057 μm |
| D 90% | 1198 μm |

*Zwick strength testing machine (Material testing 1446; weighing cell F61290)
**Erweka Friabulator, 50 g, 20 min, 20, 20 rev/min, 50 μm screen

Here, the results likewise show that the granules obtained by the process according to the invention (Table 14) had a higher granule strength and a higher resistance to abrasion than the comparison granules (Table 13).

### Example 10

### Tryptophan (Feed Grade Trp with Adhesive Addition)

A tryptophan solution containing 20% by weight of tryptophan with an adhesive addition of methylcellulose of 3% by weight based on the solid content was converted into a solid by means of fluidized bed spray granulation according to the process described in Example 9. Comminuted tryptophan mixer granules were employed as starter granules. The granules produced according to the different processes were investigated and the results obtained were as shown in the following Tables 15 and 16:

TABLE 15
Granules according to process 1 (Laboratory
granulator; comparison example)

| | |
|---|---|
| Strength | too fine |
| Abrasion** | 44% |
| D 10% | 144 μm |
| D 50% | 251 μm |
| D 90% | 385 μm |

**Erweka Friabulator, 50 g, 20 min, 20, 20 rev/min, 50 μm screen

TABLE 16
Granules according to process 2 (cycle
gas plant; according to the invention)

| | |
|---|---|
| Strength* | 1.4N |
| Abrasion** | 36% |
| D 10% | 176 μm |
| D 50% | 303 μm |
| D 90% | 517 μm |

*Zwick strength testing machine
**Erweka Friabulator, 50 g, 20 min, 20, 20 rev/min, 50 μm screen

The results show that the granules obtained by the process according to the invention (Table 16) had a higher granule strength and a higher resistance to abrasion than the comparison granules (Table 15).

1. A process for the production of granules comprising amino acids and optionally constituents of the fermentation broth for use as feed additives, comprising:
spraying an aqueous suspension or an aqueous solution comprising an amino acid in a granulation chamber equipped with a stationary or circulating fluidized bed wherein a drying gas flow on flowing into the granulation chamber has a temperature of 120 to 450° C. and a water vapour content of more than 16 g of water/kg of drying gas.

2. The process according to claim 1, wherein the drying gas flow on flowing into the granulation chamber has a water vapour content of 20 to 90 g of water/kg of drying gas.

3. The process according to claim 1, wherein the drying gas flow on flowing into the granulation chamber has a temperature of 150 to 450° C.

4. The process according to claim 1, wherein the drying gas flow on flowing into the granulation chamber has a temperature of 250 to 450° C. and a water vapour content of 20 to 70 g of water/kg of drying gas.

5. The process according to claim 1, wherein the drying gas flow on flowing into the granulation chamber has a temperature of 350 to 450° C. and a water vapour content of 20 to 70 g of water/kg of drying gas.

6. The process according to claim 1, wherein the drying gas flow on exit from the granulation chamber has a relative gas humidity of 10 to 90% of drying gas.

7. The process according to claim 1, wherein the drying gas flow on exit from the granulation chamber has an absolute gas humidity of 20 to 200 g of water/kg of drying gas.

8. The process according to claim 1, wherein the drying gas flow on flowing into the granulation chamber has a residual oxygen content of 1 to 15% by volume.

9. The process according to claim 1, wherein the drying gas flow on flowing into the granulation chamber has a carbon dioxide content of at least 6% by volume.

10. The process according to claim 1, further comprising:
a) discharging at least 10% by weight of particles situated in the granulation chamber from the granulation chamber with the drying gas flow;
b) separating off the particles from the drying gas flow;
c) feeding at least 75% of the particles separated off from the drying gas flow back to the granulation chamber; and
d) continuously removing granulated particles with a size within a desired particle size range from the granulation chamber in an amount such that the amount of solid situated in the chamber remains constant.

11. The process according to claim 1, wherein the drying gas flow separated off from the particles is at least partially fed back into the granulation chamber.

12. The process according to claim 1, wherein the drying gas flow separated off from the particles is at least partially fed back into the granulation chamber by means of an apparatus for heating the drying gas flow.

13. The process according to claim 1, wherein the amino acid has a solubility in water of less than 90 g/1 at 20° C.

14. The process according to claim 1, wherein the amino acid is selected from the group consisting of L-lysine, L-methionine, L-threonine, L-tryptophan and L-valine.

15. The process according to claim 1, wherein the amino acid comprises at least to 20% by weight of the aqueous suspension or aqueous solution.

16. The process according to claim 1, wherein the addition of binders or adhesives to the aqueous suspension or aqueous solution sprayed in the granulation chamber is adjusted such that the fraction of binders or adhesives in a granule obtained is below 5% by weight.
